(19) United States
(12) Patent Application Publication
(10) Pub. No.: US 2020/0019875 A1
(43) Pub. Date: Jan. 16, 2020

(54) PARAMETER CALCULATION DEVICE, PARAMETER CALCULATION METHOD, AND NON-TRANSITORY RECORDING MEDIUM

(71) Applicant: NEC Corporation, Minato-ku, Tokyo (JP)

(72) Inventors: Takafumi KOSHINAKA, Tokyo (JP); Takayuki SUZUKI, Tokyo (JP)

(73) Assignee: NEC Corporation, Minato-ku, Tokyo (JP)

(21) Appl. No.: 16/483,482

(22) PCT Filed: Feb. 14, 2018
(86) PCT No.: PCT/JP2018/004994

§ 371 Date: Aug. 5, 2019

(30) Foreign Application Priority Data
Feb. 17, 2017 (JP) 2017-027584

(51) Int. Cl. G06N 7/00; G06N 20/00

(52) U.S. Cl. CPC G06N 7/005; G06N 20/00

(57) ABSTRACT

Please delete the Abstract of the Disclosure, and replace it with the following: Provided is a parameter calculation device or the like that calculates a parameter with which it is possible to produce a model that is a basis for correctly classifying data. A parameter calculation device calculates a value following a predetermined distribution for relevance information and generates a class vector including the calculated value. The relevance information represents a relevance among data, the value following the predetermined distribution, an between-class scatter degree of the data, and a within-class scatter degree of the data. The data is classified into the class. The parameter calculation device estimates a degree of classification possibility in case that the data is classified into one class based on the generated class vector and the data; and calculates the between-class scatter degree and the within-class scatter degree in case of large fit degree of the data to the relevance information based on the calculated degree.

### TECHNICAL FIELD

The present invention relates to a parameter calculation device and the like that provides data that is a basis of classifying data.

### BACKGROUND ART

NPL 1 describes one example of a pattern learning device. The pattern learning device provides a classification model for use in speaker recognition that classifies speech utterances on the basis of a difference between speakers. A configuration of the pattern learning device will be described with reference to FIG. 10. FIG. 10 is a block diagram illustrating a configuration of such a pattern learning device as described in NPL 1.

A learning device 600 includes a learning unit 601, a clustering unit 602, a first objective function calculation unit 603, a parameter storage unit 604, and an audio data storage unit 605.

Audio data are stored in the audio data storage unit 605. For example, the audio data are a set of a plurality of segments in the audio data.

In the explanation below, it is assumed that class labels are not annotated to the audio data stored in the audio data storage unit 605. The class label represents information for identifying a speaker. Moreover, for convenience of explanation, it is assumed that each of the segments includes only a speech utterance uttered by a single speaker. For example, when one segment includes speech utterances of two or more speakers, the segment is divided into segments, each of which includes only a single speaker, by using a speaker segmentation unit (not illustrated), thereby a segment including only a speech utterance uttered by a single speaker can be generated. Many methods are well-known with regard to processing of generating a segment including only a speech utterance uttered by a single speaker, and accordingly, a detailed description regarding the processing will be omitted herein.

The first objective function calculation unit 603 calculates a value in accordance with processing represented by a first objective function. The clustering unit 602 uses the value calculated according to the processing represented by the first objective function in its process.

The clustering unit 602 classifies the audio data stored in the audio data storage unit 605 in such a way that the first objective function becomes maximum (or minimum), and gives a class label (hereinafter, also simply referred to as “label”), which is associated with each class, to the audio data.

The learning unit 601 executes probabilistic linear discriminant analysis (PLDA) for the class label given by the clustering unit 602 and for training data, as processing objects, and thereby estimates parameters (hereinafter, referred to as “PLDA parameters”) included in a classification model regarding the PLDA (hereinafter, referred to as “PLDA model”). PLDA is an abbreviation of probabilistic linear discriminant analysis. For example, the PLDA model is a model for use in a case of identifying a speaker regarding audio data.

A configuration of the learning unit 601 will be described in detail with reference to FIG. 11. FIG. 11 is a block diagram illustrating a configuration of the learning unit 601.

The learning unit 601 includes a parameter initialization unit 611, a class vector estimation unit 612, a parameter calculation unit 613, and a second objective function calculation unit 614.

The second objective function calculation unit 614 executes processing of calculating a value in accordance with processing represented by a second objective function different from the above-mentioned first objective function. The value calculated in accordance with the processing represented by the second objective function is used in processing of the parameter calculation unit 613. The parameter initialization unit 611 initializes PLDA parameters. The class vector estimation unit 612 estimates a speaker class vector, which is a feature of audio data, on the basis of the class label and the audio data. The parameter calculation unit 613 calculates PLDA parameters in the case where the value calculated by the second objective function calculation unit 614 is maximum (or minimum).

Next, processing in the learning device 600 will be described.

The clustering unit 602 classifies segments stored in the audio data storage unit 605 in accordance with a predetermined similarity indicator, in such a way that the value of the first objective function being calculated by the first objective function calculation unit 603 becomes maximum (or minimum), and thereby generates clusters obtained by classifying the segments. For example, the first objective function is defined based on a similarity between the above-mentioned segments. For example, the similarity is an indicator representing a degree of similarity, such as a Euclidean distance and a cosine similarity. For example, the clustering unit 602 executes processing of maximizing a similarity between segments in a cluster or processing of minimizing a similarity between different clusters as processing regarding the first objective function. Alternatively, the clustering unit 602 maximizes an information gain regarding the class label in accordance with processing derived based on an information theory. Regarding the processing in the clustering unit 602, a variety of objective functions and optimization algorithms thereof, which are applicable to speaker clustering, are well-known, and accordingly, a detailed description thereof will be omitted herein.

The learning unit 601 inputs a classification result (i.e. a class label given for each of the audio segments) output by the clustering unit 602, and further, reads the audio data stored in the audio data storage unit 605. The learning unit 601 executes supervised learning processing in accordance with maximum likelihood criteria on the basis of the read audio data and class labels regarding the audio data, thereby estimates PLDA parameters, and outputs the estimated PLDA parameters.

Moreover, PTLs 1 to 3 disclose technologies related to such a model as mentioned above.

PTL 1 discloses a document classification device that classifies electronic documents into a plurality of classes. On the basis of electronic documents which are annotated labels representing the classes, the document classification device estimates the label regarding an unlabeled electronic document.

PTL 2 discloses a learning device that outputs, to a device for determining a speaker, a discriminant function being a base of speaker estimation in the device. The discriminant function is given by a linear sum of predetermined kernel functions. The learning device calculates a coefficient that constitutes the discriminant function, based on training data including speaker labels.

PTL 3 discloses a feature calculation device that calculates a feature representing a character of image data. The feature calculation device outputs the calculated feature to a recognition device recognizing image data.

### CITATION LIST

### Patent Literature

PTL 1: Japanese Unexamined Patent Application Publication No. 2015-176511

PTL 2: Japanese Unexamined Patent Application Publication No. 2012-118668

PTL 3: Japanese Unexamined Patent Application Publication No. 2010-271787

### Non-Patent Literature

NPL 1: Subhadeep Dey, Srikanth Madikeri, and Petr Motlicek, “Information theoretic clustering for unsupervised domain-adaptation”, Proceedings of the 41st IEEE International Conference on Acoustics, Speech, and Signal Processing (ICASSP_2016), March 2016.

### SUMMARY OF INVENTION

### Technical Problem

However, a learning device as discloses in NPL 1 and the like cannot calculate optimal PLDA parameters in terms of maximum likelihood. A reason for this is that, in the learning device, class labels of unknown data (pattern) are determined in accordance with criteria (for example, criteria regarding a first objective function) different from criteria (for example, criteria regarding a second objective function) in the case of estimating PLDA parameters. A reason for this will be specifically described.

The clustering unit 602 determines class labels in accordance with the first objective function representing that a similarity (minimization) between audio segments in a cluster or the information gain is maximized. In contrast, the parameter calculation unit 613 calculates PLDA parameters on the basis of the second objective function of likelihood or the like regarding the PLDA model. Hence, the first objective function and the second objective function are different from each other. The learning device executes processing in accordance with the plurality of objective functions. Accordingly, the PLDA parameters calculated by the learning device is not always preferable from a viewpoint of maximum likelihood for the training data, and further, is not always preferable from a viewpoint of recognition accuracy, either.

Likewise, even when any of the devices disclosed in PTLs 1 to 3 is used, the parameters preferable from a viewpoint of maximum likelihood or a viewpoint of recognition accuracy is not always calculated.

In this view, one of objects of the present invention is to provide parameters calculation device and the like that calculate parameters that make it possible to generate a model serving as a base for accurately classifying data.

### Solution to Problem

As an aspect of the present invention, a parameter calculation device includes:

generation means for calculating a value following a predetermined distribution for relevance information and generating a class vector including the calculated value, the relevance information representing a relevance among data, the value following the predetermined distribution, an between-class scatter degree of the data, and a within-class scatter degree of the data, the data being classified into the class;

estimation means for estimating a degree of classification possibility in case that the data is classified into one class based on the generated class vector and the data; and

calculation means for calculating the between-class scatter degree and the within-class scatter degree in case of large fit degree of the data to the relevance information based on the degree calculated by the estimation means.

In addition, as another aspect of the present invention, a parameter calculation method includes:

calculating a value following a predetermined distribution for relevance information and generating a class vector including the calculated value, the relevance information representing a relevance among data, the value following the predetermined distribution, an between-class scatter degree of the data, and a within-class scatter degree of the data, the data being classified into the class;

estimating a degree of classification possibility in case that the data is classified into one class based on the generated class vector and the data; and

calculating the between-class scatter degree and the within-class scatter degree in case of large fit degree of the data to the relevance information based on the calculated degree.

In addition, as another aspect of the present invention, a parameter calculation program causes a computer to achieve:

a generation function for calculating a value following a predetermined distribution for relevance information and generating a class vector including the calculated value, the relevance information representing a relevance among data, the value following the predetermined distribution, an between-class scatter degree of the data, and a within-class scatter degree of the data, the data being classified into the class;

an estimation function for estimating a degree of classification possibility in case that the data is classified into one class based on the generated class vector and the data; and

a calculation function for calculating the between-class scatter degree and the within-class scatter degree in case of large fit degree of the data to the relevance information based on the degree calculated by the estimation function.

Furthermore, the object is also achieved by a computer-readable recording medium that records the program.

### Advantageous Effects of Invention

According to a parameter calculation device and the like according to the present invention, parameters that make it possible to generate a model serving as a base for accurately classifying data can be calculated.

### BRIEF DESCRIPTION OF DRAWINGS

FIG. 1 is a block diagram illustrating a configuration of a parameter calculation device according to a first example embodiment of the present invention.

FIG. 2 is a block diagram illustrating a configuration of an unsupervised learning unit according to the first example embodiment.

FIG. 3 is a flowchart illustrating a flow of processing in the parameter calculation device according to the first example embodiment.

FIG. 4 is a block diagram illustrating a configuration of a parameter calculation device according to a second example embodiment of the present invention.

FIG. 5 is a block diagram illustrating a configuration of a semi-supervised learning unit according to the second example embodiment.

FIG. 6 is a flowchart illustrating a flow of the processing in the parameter calculation device according to the second example embodiment.

FIG. 7 is a block diagram illustrating a configuration of a parameter calculation device according to a third example embodiment of the present invention.

FIG. 8 is a flowchart illustrating a flow of the processing in the parameter calculation device according to the third example embodiment.

FIG. 9 is a block diagram schematically illustrating a hardware configuration of a calculation processing device capable of achieving a parameter calculation device according to each example embodiment of the present invention.

FIG. 10 is a block diagram illustrating a configuration of a pattern learning device.

FIG. 11 is a block diagram illustrating a configuration of a learning unit.

### EXAMPLE EMBODIMENT

First, in order to facilitate the understanding of the present invention, a technology for use in the present invention will be described in detail.

Moreover, for convenience of explanation, the description below will be given by using mathematical terms such as probability, likelihood, and variance. However, the terms may be indices different from indices as defined mathematically. For example, the probability may be an indicator representing a degree of likeliness that an event occurs. For example, the likelihood may be an indicator representing a relevance (or a similarity, a compatibility, or the like) between two events. The variance may be an indicator representing a degree (scatter degree) at which certain data are scattered. In other words, a parameter calculation device according to the present invention is not limited to the processing described by using mathematical terms (for example, probability, likelihood, and variance).

In the description below, it is assumed that data such as audio data are classified into a plurality of classes. Moreover, data in a single class are sometimes represented as “pattern”. For example, in speaker recognition processing, data are an audio segment that constitutes audio data. In the speaker recognition processing, for example, each of the classes is a class for identifying a speaker.

In the case of representing a pattern (training data) in a class h (h is a natural number) by using xᵢ that is a real vector having a certain number of dimensions, the training data can be represented as in Eqn. 1.

xᵢ=μ+Vyₕ+ε (Eqn. 1)

Herein, μ is a real vector including a plurality of certain numerical values, and for example, denotes an average value of xᵢ. yₕ is a random variable following a predetermined distribution (for example, a multi-dimensional normal distribution indicated in Eqn. 2 to be described later), and is a latent variable specific to the class h. V denotes parameters representing an between-class variance among different classes. ε denotes a random variable representing a within-class variance, and for example, denotes parameters following a multi-dimensional normal distribution indicated in Eqn. 3 (to be described later).

yₕ˜N(0,I) (Eqn. 2)

Herein, I denotes an identity matrix. N(0,I) denotes a multi-dimensional normal distribution including a plurality of elements in which an average is 0 and a variance is 1.

ε˜N(0,C) (Eqn. 3)

Herein, C denotes a covariance matrix defined by using respective elements in xᵢ. N(0,C) denotes a multi-dimensional normal distribution including a plurality of elements in which an average is 0 and a variance is C.

From Eqn. 1 to Eqn. 3, the training data xᵢ follow a normal distribution in which an average is μ and a variance is (C+V^{T}V). In this variance, C denotes a noise regarding a single class vector, and accordingly, can be considered a within-class variance. Moreover, V is defined regarding different vectors, and accordingly, V^{T}V can be considered an between-class variance.

A model (PLDA model) that is a base for estimating the class on the basis of Eqn. 1 to Eqn. 3 can be considered a probability model in linear discriminant analysis (LDA). In this case, the PLDA parameters are prescribed by using a parameter θ as indicated in Eqn. 4.

θ={μ,V,C} (Eqn. 4)

The parameter θ (Eqn. 4) is determined, for example, by executing processing that follows supervised learning based on the maximum likelihood criteria. In the processing, the parameter θ (Eqn. 4) is determined on the basis of training data (i.e., a training set X=(x₁, x₂ . . . , xₙ)) and class labels (i.e., Z=(z₁, z₂ . . . , zₙ)) associated with the respective training data.

In the parameter θ (Eqn. 4), μ is calculated as an average of the training data xᵢ included in the training set X. Moreover, when the training set X is centered (i.e., when the average of the training data xᵢ included in the training set X is moved in such a way as to become average 0), μ may be 0.

By determining the value of the parameter θ (Eqn. 4), it is possible to execute recognition processing of determining the classes regarding the respective training data, in accordance with the PLDA model including the determined parameter θ. For example, a similarity S between the training data xᵢ and training data xⱼ is calculated as a log-likelihood ratio regarding two hypotheses, which are a hypothesis H₀ and a hypothesis H₁, according to such processing as indicated in Eqn. 5.

$$S = log \frac{p ( {x}_{i} , {x}_{j} \vert {H}_{1} , θ )}{p ( {x}_{i} , {x}_{j} \vert {H}_{0} , θ )} . \qquad ( Eqn . 5 )$$

Herein, the hypothesis H₀ represents a hypothesis that the training data xᵢ and the training data xⱼ belong to different classes (i.e., are represented by using different class vectors). The hypothesis H₁ represents a hypothesis that the training data xᵢ and the training data xⱼ belong to the same class (i.e., are represented by using the same class vector). For example, “log” denotes a logarithmic function having a Napier's constant as a base. “p” denotes a probability. “p(A|B)” denotes a conditional probability that an event A occurs when an event B occurs. As a value of the similarity S is larger, a possibility that the hypothesis H₁ may be established is higher. In other words, in this case, a possibility that the training data xᵢ and the training data xⱼ belong to the same class is high. As the value of the similarity S is smaller, a possibility that the hypothesis H₀ may be established is higher. In other words, in this case, a possibility that the training data xᵢ and the training data xⱼ belong to different classes is high.

Next, learning processing of calculating the parameters (Eqn. 4) will be described according to such processing as described with reference to Eqn. 1 to Eqn. 5.

In the learning processing, first, the parameters (Eqn. 4) will be initialized. Next, a posterior distribution of speaker class vectors (y₁, y₂ . . . , y_{K}) with respect to the training data (x₁, x₂ . . . , xₙ) is estimated based on the initialized parameters (Eqn. 4) (or an updated parameters after being initialized). Herein, K denotes the number of speaker class vectors. Next, parameters (Eqn. 6) in the case where the objective function (for example, a likelihood representing a degree of fitting the training data to a PLDA model including the parameters (Eqn. 6)) are the maximum (or in the case where the objective function is increased) is calculated based on the speaker class vectors.

In accordance with the expectation maximization (EM) method widely known as an algorithm regarding maximum likelihood estimation that involves a latent variable, the above-mentioned processing is repeatedly executed while values of the parameters (Eqn. 6) are not converged.

It is not always necessary that the objective function is a likelihood, and may be an auxiliary function representing a lower limit of the likelihood. By using the auxiliary function, an update processing procedure in which a monotonous increase of the likelihood is certain is obtained, and accordingly, efficient learning is possible.

Next, example embodiments of the present invention will be described in detail with reference to the drawings.

### First Example Embodiment

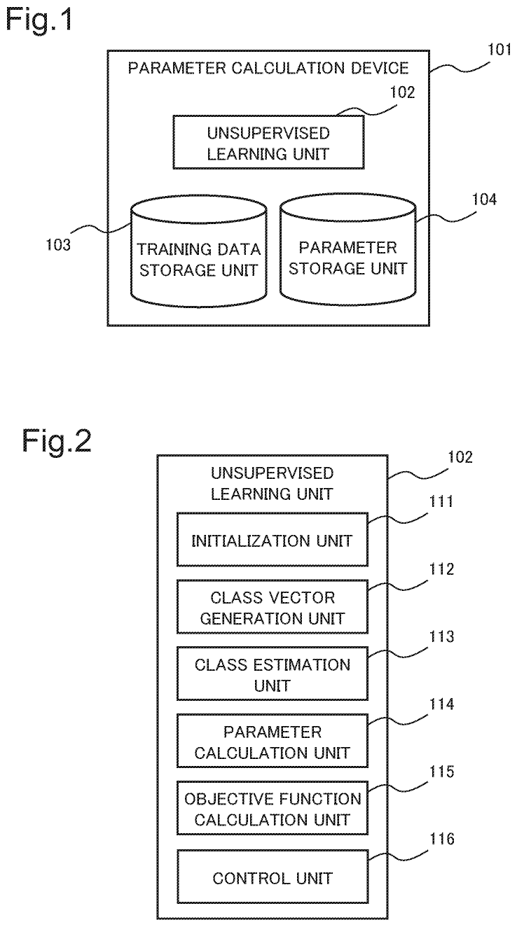

Referring to FIG. 1, a detailed description will be given of a configuration of a parameter calculation device according to a first example embodiment of the present invention. FIG. 1 is a block diagram illustrating a configuration of a parameter calculation device 101 according to the first example embodiment of the present invention.

The parameter calculation device 101 according to the first example embodiment includes an unsupervised learning unit (unsupervised learner) 102, a training data storage unit 103, and a parameter storage unit 104.

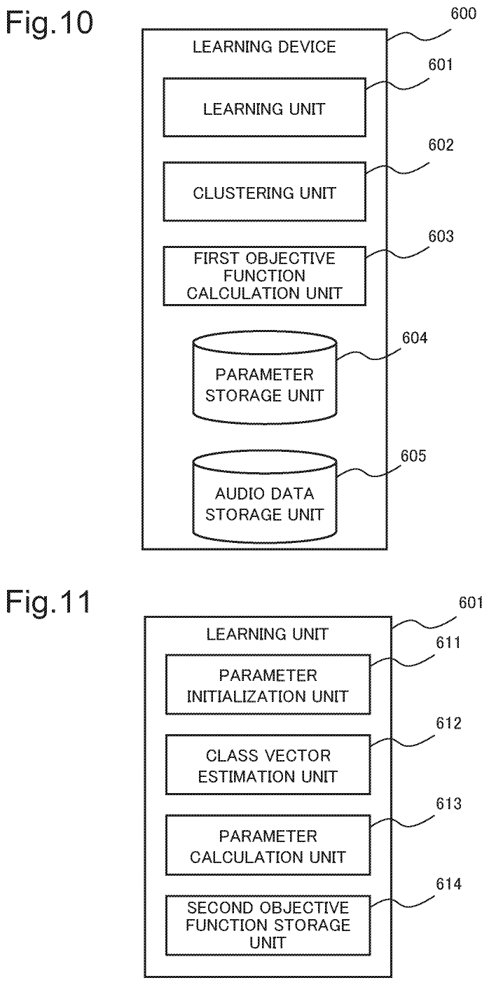

In the training data storage unit 103, training data such as the audio data as described with reference to FIG. 10 are stored. In the parameter storage unit 104, values of parameters (Eqn. 6 to be described later) of a model for the audio data is stored. The unsupervised learning unit 102 calculates the parameters (Eqn. 6, for example, a PLDA parameters) of the model for the training data stored in the training data storage unit 103 in accordance with such processing as will be described later, with reference to Eqn. 9 to Eqn. 11 (to be described later).

Referring to FIG. 2, a detailed description will be given of a configuration of the unsupervised learning unit 102 according to the first example embodiment. FIG. 2 is a block diagram illustrating a configuration of the unsupervised learning unit 102 according to the first example embodiment.

The unsupervised learning unit 102 includes an initialization unit 111, a class vector generation unit (class vector generator) 112, a class estimation unit (class estimator) 113, a parameter calculation unit (parameter calculator) 114, an objective function calculation unit (objective function calculator) 115, and a control unit (controller) 116.

The initialization unit 111 initializes values of the parameters (Eqn. 6 to be described later) stored in the parameter storage unit 104, when the unsupervised learning unit 102 inputs the training data.

The objective function calculation unit 115 calculates a value of a predetermined objective function in accordance with processing indicated in the predetermined objective function (for example, a likelihood representing a degree of fitting the training data to such a relevance as indicated in Eqn. 1).

The parameter calculation unit 114 calculates parameters (Eqn. 6 to be described later) in the case where the value, which is calculated by the objective function calculation unit 115, of the predetermined objective function is increased (or when the value is the maximum) in accordance with such processing as will be described later with reference to Eqn. 9 to Eqn. 11.

The class estimation unit 113 estimates class labels for each piece of training data stored in the training data storage unit 103 based on a model including the parameters (Eqn. 6) calculated by the parameter calculation unit 114 in accordance with such processing as will be described later with reference to Eqn. 8.

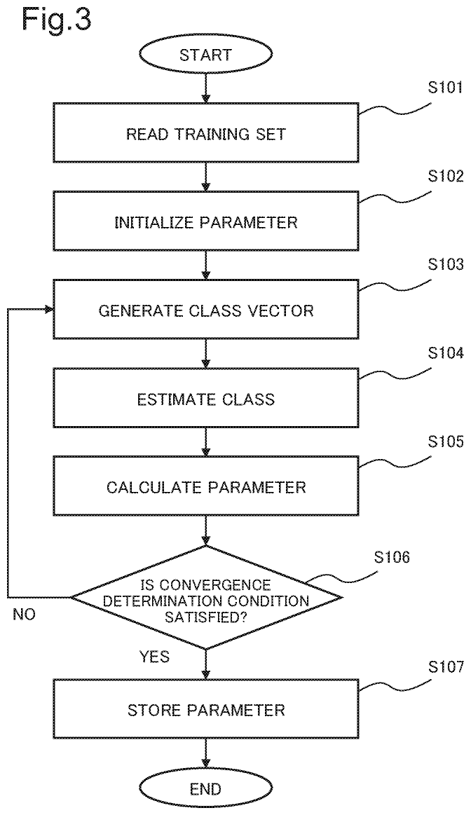

The class vector generation unit 112 calculates a class vector regarding each class in accordance with processing (to be described later with reference to FIG. 3) indicated in Step S103. For example, the class vector is yₕ indicated in Eqn. 1 and is a latent variable defined for each class.

Pieces of the processing (i.e., Step S103 to Step S106 in FIG. 3) in the parameter calculation unit 114, the class estimation unit 113, the class vector generation unit 112, and the like are executed alternately and repeatedly, for example, when the value of the predetermined objective function is a predetermined value or less. As a result of such repeated processing, the parameters (Eqn. 6) in the case where the predetermined objective function is larger than a predetermined value is calculated.

Next, referring to FIG. 3, a detailed description will be given of processing in the parameter calculation device 101 according to the first example embodiment of the present invention. FIG. 3 is a flowchart illustrating a flow of the processing in the parameter calculation device 101 according to the first example embodiment.

The parameter calculation device 101 reads the training set X (=(x₁, x₂ . . . , xₙ)) stored in the training data storage unit 103 (Step S101). Next, the initialization unit 111 initializes the parameters (Eqn. 6) stored in the parameter storage unit 104 (Step S102).

θ={μ,V,C,Π} (Eqn. 6)

Herein, Π denotes a prior probability (π₁, π₂ . . . , π_{K}) regarding each class, where “π₁+π₂+ . . . +π_{K}=1” is established. Moreover, K denotes the number of classes.

The initialization processing by the initialization unit 111 may be, for example, processing of setting a certain constant or a value representing a probability, processing of setting such a plurality of values of which sum is 1 for respective parameters, processing of setting an identity matrix or the like, and processing of setting an average and a variance regarding the training set. Alternatively, the initialization processing may be processing of setting a value calculated in accordance with a statistical analysis procedure such as a principal component analysis, or the like. In short, the initialization processing is not limited to the above-mentioned example.

For convenience of explanation, it is assumed that the training set X is centered. In other words, in Eqn. 6, it is assumed that μ as the average of the respective data in the training set X is set to be 0. When the training set X is not centered, an average value of the respective data just needs to be calculated in the processing illustrated in FIG. 3.

The class vector generation unit 112 calculates the class vector Y (=(y₁, y₂ . . . , y_{K})) on the basis of the training set read by the initialization unit 111 (Step S103). yᵢ (where 1≤i≤K) denotes a value for the class i. As indicated in Eqn. 2, when the class vector follows the standard normal distribution N(0,I), the class vector generation unit 112 calculates a plurality of values, for example, in accordance with processing based on random numbers, such as the Box Muller's method, and generates the class vector Y including the plurality of calculated values.

The class vector generation unit 112 may generate a plurality of the class vectors. For example, the class vector generation unit 112 generates m (where m≥2) pieces of class vectors (i.e., Y⁽¹⁾, Y⁽²⁾ . . . , Y^{(m)}). In the parameter calculation device 101, processing regarding the plurality of class vectors is executed, whereby a computational reliability related to the calculated value regarding the parameters (Eqn. 6) is increased. Moreover, one of reasons why the class vector generation unit 112 generates the class vector based on the random numbers is that it is difficult to acquire an analytical solution in the unsupervised learning unlike in the supervised learning.

The class estimation unit 113 estimates to which class among K pieces of class vectors each piece of the training data xᵢ (1≤i≤n) in the training set X belongs (Step S104). The processing regarding Step S104 will be specifically described. It is assumed that the class estimation unit 113 inputs parameters indicated in Eqn. 7.

θₜₑₘₚ={Vₜₑₘₚ,Cₜₑₘₚ,Πₜₑₘₚ} (Eqn. 7)

Herein, Vₜₑₘₚ denotes a parameter representing an between-class variance among different classes. Cₜₑₘₚ denotes a value of a within-class variance parameters. Πₜₑₘₚ denotes a value of a prior probability regarding such a class as mentioned above. Moreover, regarding the training set, since such centering processing as mentioned above is applied thereto, the description regarding μ is omitted in Eqn. 7.

The class estimation unit 113 calculates a probability, at which each piece of the training data xᵢ belongs to the class k(1≤k≤K) regarding m pieces of class vectors Y^{(j)}(1≤j≤m), in accordance with processing indicated in Eqn. 8 for the input parameters (Eqn. 7).

$$p ( {Z}_{ik} = 1 \vert {x}_{i} , {Y}^{( j )} , {θ}_{temp} ) = \frac{{\overline{π}}_{k} exp [ - \frac{1}{2} {( {x}_{i} - {V}_{temp} {y}_{k}^{( j )} )}^{T} {C}_{temp}^{- 1} ( {x}_{i} - {V}_{temp} {y}_{k}^{( j )} ) ]}{{\sum }_{{k}^{′} = 1}^{K} {\overline{π}}_{{k}^{′}} exp [ - \frac{1}{2} {( {x}_{i} - {V}_{temp} {y}_{{k}^{′}}^{( j )} )}^{T} {C}_{temp}^{- 1} ( {x}_{i} - {V}_{temp} {y}_{{k}^{′}}^{( j )} ) ]} \qquad ( Eqn . 8 )$$

where, Πₜₑₘₚ=(π̅₁, π̅₂, . . . , π̅_{K})

Herein, Y^{(j)}=(y^{(j)}₁, y^{(j)}₂ . . . , y^{(j)}_{K}) is established. “Zᵢₖ=1” represents that the training data xᵢ belongs to the class k(1≤k≤K). Moreover, “exp” denotes an exponential function having a Napier's constant as a base. Further, Cₜₑₘₚ⁻¹ denotes processing of calculating an inverse matrix of Cₜₑₘₚ. A letter “T” put to an upper right of a certain letter denotes processing of transposing a row and a column.

After the processing illustrated in Step S104, the parameter calculation unit 114 inputs the class vector Y generated by the class vector generation unit 112 and the probability (Eqn. 8) estimated by the class estimation unit 113, and acquires the parameter (Eqn. 6) in accordance with processing indicated in Eqn. 9 to Eqn. 11 (Step S105).

$$\begin{matrix}V = ( {\sum }_{j = 1}^{m} {\sum }_{i = 1}^{n} {\sum }_{k = 1}^{K} p ( {z}_{ik} = 1 \vert {x}_{i} , {Y}^{( j )} , {θ}_{temp} ) {x}_{i} {y}_{k}^{{( j )}^{T}} ) {( {\sum }_{j = 1}^{m} {\sum }_{i = 1}^{n} {\sum }_{k = 1}^{K} p ( {z}_{ik} = 1 \vert {x}_{i} , {Y}^{( j )} , {θ}_{temp} ) {y}_{k}^{( j )} {y}_{k}^{{( j )}^{T}} )}^{- 1} & ( Eqn . 9 ) \\ C = \frac{1}{n} {\sum }_{j = 1}^{m} {\sum }_{i = 1}^{n} {\sum }_{k = 1}^{K} p ( {z}_{ik} = 1 \vert {x}_{i} , {Y}^{( j )} , {θ}_{temp} ) \times ( {x}_{i} - {Vy}_{k}^{( j )} ) {( {x}_{i} - {Vy}_{k}^{( j )} )}^{T} & ( Eqn . 10 ) \\ {π}_{k} = \frac{{\sum }_{j = 1}^{m} {\sum }_{i = 1}^{n} p ( {z}_{ik} = 1 \vert {x}_{i} , {Y}^{( j )} , {θ}_{temp} )}{{\sum }_{{k}^{′} = 1}^{K} {\sum }_{j = 1}^{m} {\sum }_{i = 1}^{n} p ( {z}_{{ik}^{′}} = 1 \vert {x}_{i} , {Y}^{( j )} , {θ}_{temp} )} & ( Eqn . 11 )\end{matrix}$$

Herein, “Σ” denotes processing of summation.

Note that Eqn. 9 represents processing of calculating parameters representing an between-class variance representing features of the audio data. Eqn. 10 represents processing of calculating a within-class variance. Eqn. 11 represents processing of calculating a prior distribution of the respective classes.

Pieces of the processing indicated in Eqn. 9 to Eqn. 11 are processing acquired based on the expectation maximization (EM) method. On the premise of the acquired parameters, the processing is ensured to be maximizing the objective function (for example, an auxiliary function defined as a lower limit of a likelihood). In other words, the parameter calculation unit 114 executes the processing indicated in Eqn. 9 to Eqn. 11, thereby calculates the parameters (Eqn. 6) in the case where a value of a predetermined objective function is increased (or in the case where the value of the predetermined objective function is the maximum).

The control unit 116 determines whether a predetermined convergence determination condition is satisfied (Step S106). The predetermined convergence determination condition is that an increase of the value of the predetermined objective function is smaller than a predetermined threshold value, that a sum of variations of the parameters calculated in accordance with Eqn. 9 to Eqn. 11 is smaller than a predetermined threshold value, that the class (i.e., the class to which the training data xᵢ belong) calculated in accordance with the processing indicated in Eqn. 12 (to be described later) is not changed, or the like.

When the predetermined convergence determination condition is not satisfied (NO in Step S106), the control unit 116 performs a control to execute the processing, which is illustrated in Step S103 to Step S106, on the basis of the values individually calculated by the class vector generation unit 112, the class estimation unit 113, and the parameter calculation unit 114. For example, the parameter calculation unit 114 may calculate the class of the training data xᵢ in accordance with such processing as indicated in Eqn. 12.

maxₖΣⱼ₌₁^{m}p(zᵢₖ=1|xᵢ,Y^{(j)},θ) (Eqn. 12)

Herein, “max_{K}” denotes processing of calculating a class k in the case where a value of a result of an arithmetic operation on the right is the maximum.

When the predetermined convergence determination condition is satisfied (YES in Step S106), the unsupervised learning unit 102 stores the parameters (Eqn. 6) satisfying the predetermined convergence determination condition in the parameter storage unit 104 (Step S107).

In the above-mentioned processing, it is assumed that the number of classes K regarding the training set X is given. However, the number of classes K may be calculated in accordance with predetermined processing. In this case, the parameter calculation device 101 includes a number calculation unit (not illustrated) that calculates the number of classes K in accordance with the predetermined processing. The predetermined processing may be, for example, processing of setting a predetermined value of the number of classes K. Even when the predetermined number and the actual number of classes are different from each other, the values of the parameters (Eqn. 6), which is as described with reference to Eqn. 1 to Eqn. 12, is not largely affected by the fact that the predetermined value and the actual number of classes are different from each other.

Moreover, the predetermined processing may be processing of estimating the number of classes on the basis of the training set X. For example, the number calculation unit (not illustrated) calculates the number of classes based on a value of a predetermined objective function (a degree of fitting the training data to the PLDA model (for example, a likelihood)) and a complexity regarding the PLDA model (i.e., the number of classes). Processing of calculating the number of classes may be processing of calculating the number of classes, which is fit for accurately estimating a class regarding unknown data, for example, on the basis of the Akaike's information criterion and the minimum description length (MDL).

The predetermined objective function is not limited to the likelihood or the auxiliary function that calculates a smaller value than a lower limit of the likelihood. For example, the processing of acquiring the parameters (Eqn. 6) in the case where the likelihood is the maximum may be processing of acquiring parameters (Eqn. 6) in the case where a posterior probability defined, in the case where a prior probability regarding the parameters (Eqn. 6) is given, is maximum, or processing of acquiring parameters (Eqn. 6) in the case where a Bayesian marginal probability for the training data is the maximum. In short, the processing of acquiring the parameters (Eqn. 6) is not limited to the above-mentioned example.

Next, a description will be given of an advantageous effect of the parameter calculation device 101 according to the first example embodiment of the present invention.

The parameter calculation device 101 according to the first example embodiment can calculate the parameters that make it possible to generate a model that serves as a base for accurately classifying data. A reason for this is that, when the parameter calculation device 101 is processed in accordance with a single objective function, a learning model calculated in accordance with the objective function is appropriate as a base for estimating a label with high accuracy. In other words, the parameter calculation device 101 according to the first example embodiment can acquire optimal parameters (Eqn. 6) from a viewpoint of a single objective function (likelihood or the like). A reason for this is as follows. Even when class labels are not annotated to the training data, the class vector generation unit 112, the class estimation unit 113, and the parameter calculation unit 114 acquire, while performing the processing with one another, the parameters (Eqn. 6) in the case where the value of the objective function calculated by the objective function calculation unit 115 is increased (or in the case where the value is maximum).

### Second Example Embodiment

Next, a description will be given of a second example embodiment of the present invention, which is based on the above-mentioned first example embodiment.

In the description below, characteristic portions according to this example embodiment will be mainly described, and the same reference numerals will be assigned to similar components to those of the above-mentioned first example embodiment, whereby a repeated description will be omitted.

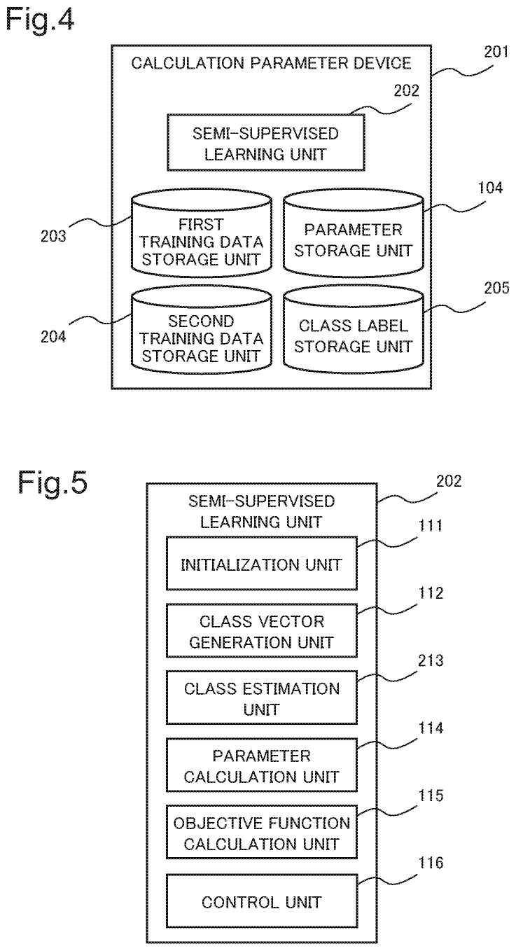

Referring to FIG. 4, a detailed description will be given of a configuration of a parameter calculation device 201 according to the second example embodiment of the present invention. FIG. 4 is a block diagram illustrating the configuration of the parameter calculation device 201 according to the second example embodiment of the present invention.

The parameter calculation device 201 includes a semi-supervised learning unit (semi-supervised learner) 202, a first training data storage unit 203, a second training data storage unit 204, a parameter storage unit 104, and a class label storage unit 205.

First training data are stored in the first training data storage unit 203. For example, the first training data are similar data to such training data as described with reference to FIG. 1. Hence, the first training data storage unit 203 can be achieved by using the training data storage unit 103 in FIG. 1.

Second training data are stored in the second training data storage unit 204. For example, the second training data are similar data to such training data as described with reference to FIG. 1. Hence, the second training data storage unit 204 can be achieved by using the training data storage unit 103 in FIG. 1.

In the class label storage unit 205, class labels (hereinafter, also simply referred to as “label”) of the second training data are stored. In other words, in the class label storage unit 205, class labels associated with the second training data are stored. The class label is information representing a class of the second training data.

Hence, the first training data are data that are not labeled (i.e., “unlabeled data”). The second training data are data that are labeled (i.e., “labeled data”).

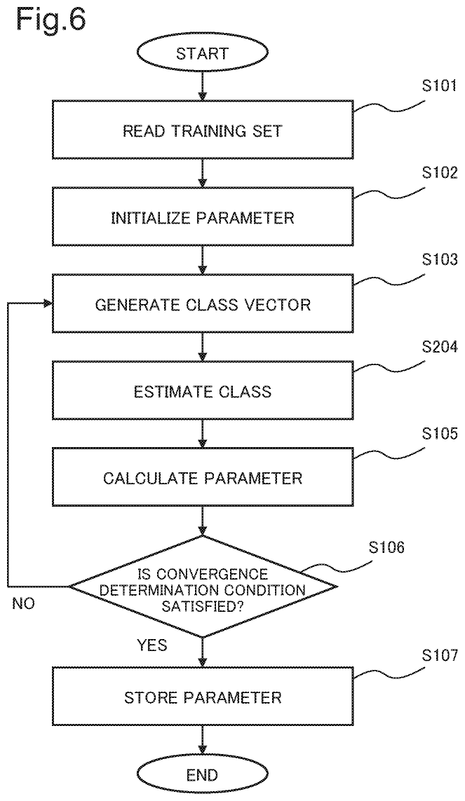

The semi-supervised learning unit 202 estimates the parameters (Eqn. 6) of the model in accordance with such processing as will be described later with reference to FIG. 6 based on the labeled data and the unlabeled data.

Referring to FIG. 5, a detailed description will be given of a configuration of the semi-supervised learning unit 202 according to the second example embodiment. FIG. 5 is a block diagram illustrating the configuration of the semi-supervised learning unit 202 according to the second example embodiment.

The semi-supervised learning unit 202 includes an initialization unit (initializer) 111, a class vector generation unit (class vector generator) 112, a class estimation unit (class estimator) 213, a parameter calculation unit (parameter calculator) 114, an objective function calculation unit (objective function calculator) 115, and a control unit (controller) 116.

The semi-supervised learning unit 202 has a similar configuration to the configuration of the unsupervised learning unit 102 according to the first example embodiment, with regard to the respective components other than the class estimation unit 213. When the semi-supervised learning unit 202 and the semi-supervised learning unit 202 are compared with each other, for example, the unsupervised learning unit 102 is different from the semi-supervised learning unit 202 in that, while the unsupervised learning unit 102 inputs the unlabeled data, the semi-supervised learning unit 202 inputs the unlabeled data and the labeled data.

With regard to only the unlabeled data (i.e., the first training data), the class estimation unit 213 calculates a probability, at which training data i belongs to a class k, in accordance with such processing as mentioned above with reference to Eqn. 8. Thereafter, with regard to the labeled data (i.e., the second training data and the label of the second training data), the class estimation unit 213 sets, to “1”, a probability regarding a class represented by the label associated with the second training data, and sets, to “0”, a probability regarding a class different from the class.

The class estimation unit 213 may set, to a first value, the probability of the class represented by the label associated with the second training data, and may set, to a second value, the probability of a class different from the class. In this case, the first value just needs to be a value larger than the second value, and a sum of the first value and the second value just needs to be 1. The first value and the second value do not have to be predetermined values, and may be random numbers (or pseudo random numbers). The probability sets by the class estimation unit 213 is not limited to the above-mentioned example. At least either one of the first value and the second value is calculated in accordance the random numbers, whereby an overlearning problem can be reduced. Accordingly, the parameter calculation device 201 can calculate parameters that make it possible to generate a model that serves as a base for classifying data more accurately.

For the probabilities calculated by the class estimation unit 213, the parameter calculation unit 114 executes similar processing to the processing indicated in Eqn. 9 to Eqn. 11, thereby calculates the parameters (Eqn. 6). In other words, the parameter calculation unit 114 executes similar processing to the processing indicated in Eqn. 9 to Eqn. 11, thereby calculates the parameters (Eqn. 6) on the basis of the probabilities calculated regarding the labeled data and the unlabeled data.

Next, referring to FIG. 6, a detailed description will be given of processing in the parameter calculation device 201 according to the second example embodiment of the present invention. FIG. 6 is a flowchart illustrating a flow of the processing in the parameter calculation device 201 according to the second example embodiment.

The semi-supervised learning unit 202 reads a training set including the unlabeled data and the labeled data (Step S101). In other words, the semi-supervised learning unit 202 reads the unlabeled data (i.e., the first training data) from the first training data storage unit 203, and reads the labeled data (i.e., the second training data and the label associated with the second training data) from the second training data storage unit 204 and the class label storage unit 205.

The initialization unit 111 initializes the parameters (Eqn. 6) (Step S102). Processing of initializing the parameters (Eqn. 6) may be similar processing to the processing mentioned above in the first example embodiment, or may be processing different therefrom. For example, the initialization unit 111 applies supervised learning based on the maximum likelihood criteria to the labeled data, and thereby, may calculate a value of each parameters (Eqn. 6), and may set the calculated value as an initial value of the parameters (Eqn. 6).

The class vector generation unit 112 executes similar processing to the processing mentioned above with reference to FIG. 3, thereby generates a class vector (Step S103).

The class estimation unit 213 estimates classes individually regarding the unlabeled data and the labeled data (Step S204). Processing in Step S204 will be specifically described. For the first training data (i.e., the unlabeled data), the class estimation unit 213 calculates a probability, at which the first training data xᵢ belong to the class k, in accordance with such processing as described with reference to Eqn. 8. Next, with regard to the labeled data (i.e., the second training data and the class label associated with the second training data), the class estimation unit 213 sets, to 1, the probability at which the second training data xᵢ belong to the class represented by the class label. With regard to the labeled data, the class estimation unit 213 sets, to 0, the probability at which the second training data xᵢ belong to the class different from the class represented by the class label.

The parameter calculation unit 114 inputs the class vector Y generated by the class vector generation unit 112 and the probability (Eqn. 8) estimated by the class estimation unit 213, and calculates the parameters (Eqn. 6) in accordance with the processing indicated in Eqn. 9 to Eqn. 11. The parameter calculation unit 114 executes the processing indicated in Eqn. 9 to Eqn. 11, thereby calculates the parameters (Eqn. 6) in the case where a predetermined objective function is increased (or is the maximum). Note that, in this processing, i indicated in Eqn. 9 to Eqn. 11 is a subscript indicating the labeled data and the unlabeled data.

Thereafter, the processing illustrated in Step S106 and Step S107 is executed.

Next, a description will be given of an effect regarding the parameter calculation device 201 according to the second example embodiment of the present invention.

According to the parameter calculation device 201 according to the second example embodiment, the parameters that make it possible to generate a model that serves as a base for accurately classifying data can be calculated. A reason for this is a similar reason to the reason described in the first example embodiment.

The parameter calculation device 201 according to the second example embodiment can generate a model that serves as a base for far more accurately estimating the label. A reason for this is that the parameters (Eqn. 6) are calculated on the basis of the unlabeled data and the labeled data. A reason for this will be described more specifically.

The class estimation unit 213 calculates a probability at which the first training data (i.e., the unlabeled data) belongs to a certain class, and further, with regard to the labeled data, sets a probability, at which the labeled data belong to a certain class depending on the label in accordance with such processing as mentioned above with reference to FIG. 6. Hence, the parameter calculation device 201 calculates the parameters (Eqn. 6) based on the unlabeled data and the labeled data, and accordingly, a ratio of the labeled data is increased in comparison with the first example embodiment. As a result, the parameter calculation device 201 can calculate such parameters (Eqn. 6) that serves as a base for far more accurately estimating the label.

### Third Example Embodiment

Next, a third example embodiment of the present invention will be described.

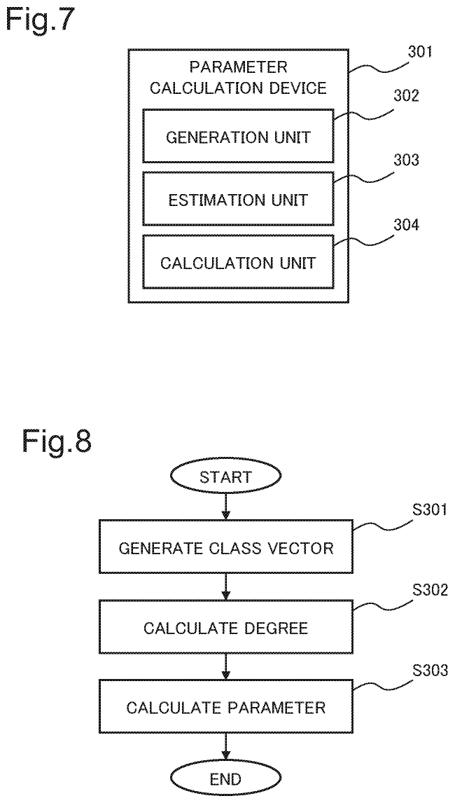

Referring to FIG. 7, a detailed description will be given of a configuration of a parameter calculation device 301 according to the third example embodiment of the present invention. FIG. 7 is a block diagram illustrating the configuration of the parameter calculation device 301 according to the third example embodiment of the present invention.

The parameter calculation device 301 according to the third example embodiment includes a generation unit (generator) 302, an estimation unit (estimator) 303, and a calculation unit (calculator) 304.

Next, referring to FIG. 8, a detailed description will be given of processing in the parameter calculation device 301 according to the third example embodiment of the present invention. FIG. 8 is a flowchart illustrating a flow of the processing in the parameter calculation device 301 according to the third example embodiment.

For example, the generation unit 302 inputs values of parameters included in relevance information representing such a relevance as exemplified in Eqn. 1. The relevance information is information representing a relevance among audio data (for example, xᵢ in Eqn. 1) uttered by a speaker, a value (for example, yₕ in Eqn. 2) following a predetermined distribution (for example, the normal distribution exemplified in Eqn. 2), an between-class variance (for example, V in Eqn. 1) among different classes, and a within-class variance (for example, ε in Eqn. 1). The generation unit 302 inputs the between-class variance among different classes and the within-class variance as values of parameters related to the relevance.

The generation unit 302 calculates a value following the predetermined distribution (Step S301). The generation unit 302 calculates a value having the variance regarding the predetermined distribution, for example, in accordance with such a Box Muller's method as mentioned above. For example, the generation unit 302 calculates values. The number of the values is equivalent to the number of classes.

For the values and the audio data, the estimation unit 303 executes similar processing to the processing illustrated in Step S104 (FIG. 3) or Step S204 (FIG. 6), thereby calculates a degree (for example, a probability) at which the audio data are classified into a single class (Step S302). In the relevance information indicated in Eqn. 1, a single class can be defined, for example, on the basis of a degree at which coefficients (i.e., yᵢ) of the between-class variances are similar to each other.

Next, the calculation unit 304 inputs the degree calculated by the estimation unit 303, and executes the processing, which is described with reference to Eqn. 9 to Eqn. 11, by using the input degree, thereby calculates the parameters (for example, an between-class variance and a within-class variance) (Step S303). Hence, the calculation unit 304 calculates parameters (Eqn. 6) in the case where a degree of fitting the audio data to the relevance information is increased (or is the maximum).

For example, a predetermined number of times, the parameter calculation device 301 may execute the repetitive processing (Step S103 to Step S106) illustrated in FIG. 3, or the repetitive processing (Step S103, Step S204, Step S105, and Step S106) illustrated in FIG. 6. Moreover, for example, the parameter calculation device 301 executes similar processing to the above-mentioned processing with reference to Eqn. 12, and thereby, may determine whether or not to execute such repetitive processing as mentioned above. The processing in the parameter calculation device 301 is not limited to the above-mentioned example.

Hence, the generation unit 302 can be achieved by using a similar function to the function having in such a class vector generation unit 112 (FIG. 2 or FIG. 5) as mentioned above. The estimation unit 303 can be achieved by using a similar function to the function having in the class estimation unit 113 according to the first example embodiment or the class estimation unit 213 according to the second example embodiment. The calculation unit 304 can be achieved by using a similar function to the functions having in the parameter calculation unit 114, the objective function calculation unit 115, and the control unit 116 (each in FIG. 2 or FIG. 5), which are as mentioned above. That is, the parameter calculation device 301 can be achieved by using a similar function to the function having in the parameter calculation device 101 (FIG. 1) according to the first example embodiment or the parameter calculation device 201 (FIG. 4) according to the second example embodiment.

Next, a description will be given of an advantageous effect regarding the parameter calculation device 301 according to the third example embodiment of the present invention.

The parameter calculation device 301 according to the third example embodiment can calculate the parameters that make it possible to generate a model that serves as a base for accurately classifying data. A reason for this is that the parameter calculation device 301 calculates the parameters (Eqn. 6) constituting a model based on a single objective function. In other words, an accurate model can be generated more often in the case of calculating the parameters in accordance with a single objective function than in the case of calculating the parameters on the basis of two different objective functions. Accordingly, the parameter calculation device 301 can calculate the parameters that make it possible to generate a model that serves as a base for accurately classifying data.

In the above-mentioned example embodiments, the processing in the parameter calculation devices is described by taking the audio data as an example. However, the audio data may be data different from the audio data, such as image data of a face image and the like and a speech utterance signal.

For example, in the case of a face recognition device that recognizes a face image, the training set X is coordinate data of feature points extracted from each face image, and the class label Z is a person identifier (ID) to be linked with the face image. The face recognition device generates a PLDA model on the basis of these data.

For example, in the case of a speaker recognition device, the training set X is statistic amount data (GMM super vector, i-vector or the like, which is widely used in speaker recognition) of sound feature or the like extracted from the audio signal, and the class label Z is an ID of a speaker who has uttered a speech utterances. The speaker recognition device generates a PLDA model on the basis of these data. GMM is an abbreviation of Gaussian mixture model.

In other words, the parameter calculation device is not limited to the above-mentioned examples.

(Hardware Configuration Example)

A configuration example of hardware resources that achieve a parameter calculation device according to each example embodiment of the present invention will be described. However, the parameter calculation device may be achieved using physically or functionally at least two calculation processing devices. Further, the parameter calculation device may be achieved as a dedicated device.

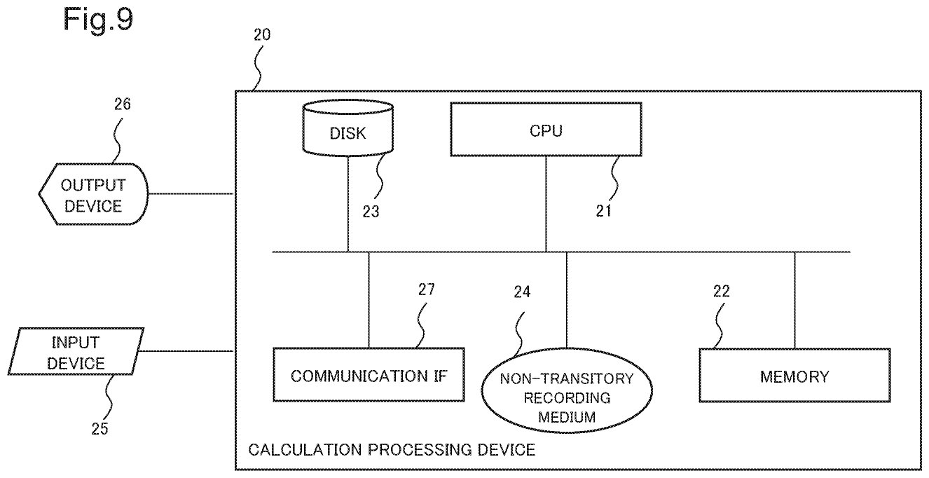

FIG. 9 is a block diagram schematically illustrating a hardware configuration of a calculation processing device capable of achieving a parameter calculation device according to each example embodiment of the present invention. A calculation processing device 20 includes a central processing unit (CPU) 21, a memory 22, a disk 23, a non-transitory recording medium 24, and a communication interface (hereinafter, referred to as. “communication I/F”) 27. The calculation processing device 20 may connect an input device 25 and an output device 26. The calculation processing device 20 can execute transmission/reception of information to/from another calculation processing device and a communication device via the communication I/F 27.

The non-transitory recording medium 24 is, for example, a computer-readable Compact Disc, Digital Versatile Disc. The non-transitory recording medium 24 may be Universal Serial Bus (USB) memory, Solid State Drive or the like. The non-transitory recording medium 24 allows a related program to be holdable and portable without power supply. The non-transitory recording medium 24 is not limited to the above-described media. Further, a related program can be carried via a communication network by way of the communication I/F 27 instead of the non-transitory recording medium 24.

In other words, the CPU 21 copies, on the memory 22, a software program (a computer program: hereinafter, referred to simply as a “program”) stored in the disk 23 when executing the program and executes arithmetic processing. The CPU 21 reads data necessary for program execution from the memory 22. When display is needed, the CPU 21 displays an output result on the output device 26. When a program is input from the outside, the CPU 21 reads the program from the input device 25. The CPU 21 interprets and executes a parameter calculation program (FIG. 3, FIG. 6, or FIG. 8) present on the memory 22 corresponding to a function (processing) indicated by each unit illustrated in FIG. 1, FIG. 2 FIG. 4, FIG. 5, or FIG. 7 described above. The CPU 21 sequentially executes the processing described in each example embodiment of the present invention.

In other words, in such a case, it is conceivable that the present invention can also be made using the parameter calculation program. Further, it is conceivable that the present invention can also be made using a computer-readable, non-transitory recording medium storing the parameter calculation program.

The present invention has been described using the above-described example embodiments as example cases. However, the present invention is not limited to the above-described example embodiments. In other words, the present invention is applicable with various aspects that can be understood by those skilled in the art without departing from the scope of the present invention.

This application is based upon and claims the benefit of priority from Japanese patent application No. 2017-027584, filed on Feb. 17, 2017, the disclosure of which is incorporated herein in its entirety.

### REFERENCE SIGNS LIST

101 parameter calculation device
102 unsupervised learning unit
103 training data storage unit
104 parameter storage unit
111 initialization unit
112 class vector generation unit
113 class estimation unit
114 parameter calculation unit
115 objective function calculation unit
116 control unit
201 calculation parameter device
202 semi-supervised learning unit
203 first training data storage unit
204 second training data storage unit
205 class label storage unit
213 class estimation unit
301 parameter calculation device
302 generation unit
303 estimation unit
304 calculation unit
20 calculation processing device
21 CPU
22 memory
23 disk
24 non-transitory recording medium
25 input device
26 output device
27 communication IF
600 learning device
601 learning unit
602 clustering unit
603 first objective function calculation unit
604 parameter storage unit
605 audio data storage unit
611 parameter initialization unit
612 class vector estimation unit
613 parameter calculation unit
614 second objective function storage unit

What is claimed is:

1. A parameter calculation device comprising:
a memory storing instructions; and
a processor connected to the memory and configured to executes the instructions to:
calculate a value following a predetermined distribution for relevance information and generate a class vector including the calculated value, the relevance information representing a relevance among data, the value following the predetermined distribution, an between-class scatter degree of the data, and a within-class scatter degree of the data, the data being classified into the class;
estimate a degree of classification possibility in case that the data is classified into one class based on the generated class vector and the data; and
calculate the between-class scatter degree and the within-class scatter degree in case of large fit degree of the data to the relevance information based on the calculated degree.

2. The parameter calculation device according to claim 1, wherein
the processor configured to
determine whether or not the fit degree is larger than a predetermined value,
when the fit degree is smaller than the predetermined value,
the processor generates the class vector,
calculates the degree based on the generated class vector, and
calculates the between-class scatter degree and the within-class scatter degree based on the calculated degree.

3. The parameter calculation device according to claim 1, wherein
the processor configured to
calculate the degree of the classification possibility based on an objective function representing that a posterior probability is maximum, the posterior probability representing a fit degree of the data to a model represented by using the between-class scatter degree and the within-class scatter degree.

4. The parameter calculation device according to claim 1, wherein
the processor configured to
calculate the value following the predetermined distribution by using random numbers or pseudo-random numbers.

5. The parameter calculation device according to claim 2, wherein
the processor configured to
calculate a plurality of class vectors,
calculate degrees of classification possibilities for the plurality of class vectors,
calculate the between-class scatter degree and the within-class scatter degree based on the calculated degree for the plurality of class vectors, and
calculate the fit degree by calculating a sum of the degrees of the calculated classification possibilities for the plurality of class vectors.

6. The parameter calculation device according to claim 1, wherein
the degree of the classification possibility is a probability and
the processor configured to set a probability of allocating the class label to the data to 1 and sets a probability of allocating another class to the data to 0 depending on class labels of the data.

7. The parameter calculation device according to claim 1, wherein
the degree of the classification possibility is a probability and
the processor configured to set a probability of allocating the class label to the data to a first value and sets a probability of allocating another class label to the data to a second value smaller than the first value.

8. The parameter calculation device according to claim 7, wherein
the processor configured to calculate the first value and the second value in accordance with a random number or a pseudo-random number.

9. A parameter calculation method by an information processing device, the method comprising:
calculating a value following a predetermined distribution for relevance information and generating a class vector including the calculated value, the relevance information representing a relevance among data, the value following the predetermined distribution, an between-class scatter degree of the data, and a within-class scatter degree of the data, the data being classified into the class;
estimating a degree of classification possibility in case that the data is classified into one class based on the generated class vector and the data; and
calculating the between-class scatter degree and the within-class scatter degree in case of large fit degree of the data to the relevance information based on the calculated degree.

10. A non-transitory recording medium storing a parameter calculation program causing a computer to achieve:
a generation function configured to calculate a value following a predetermined distribution for relevance information and generate a class vector including the calculated value, the relevance information representing a relevance among data, the value following the predetermined distribution, an between-class scatter degree of the data, and a within-class scatter degree of the data, the data being classified into the class;
an estimation function configured to estimate a degree of classification possibility in case that the data is classified into one class based on the generated class vector and the data; and
a calculation function configured to calculate the between-class scatter degree and the within-class scatter degree in case of large fit degree of the data to the relevance information based on the degree calculated by the estimation function.
